(19) United States
(12) Patent Application Publication
(10) Pub. No.: US 2025/0052528 A1
(43) Pub. Date: Feb. 13, 2025

(54) HEAT EXCHANGER AND BYPASS VALVE USED IN HEAT EXCHANGER

(71) Applicant: Hanon Systems, Daejeon (KR)

(72) Inventors: Ji Hoon CHOI, Daejeon (KR); Jun-Il JANG, Daejeon (KR); Wontaek LEE, Daejeon (KR); Jong Du LEE, Daejeon (KR); Wi Sam JO, Daejeon (KR)

(21) Appl. No.: 18/718,277

(22) PCT Filed: Dec. 8, 2022
(86) PCT No.: PCT/KR2022/019926

§ 371 Date: Jun. 10, 2024

(30) Foreign Application Priority Data
Dec. 10, 2021 (KR) 10-2021-0176557
Oct. 11, 2022 (KR) 10-2022-0129882

(51) Int. Cl. F28F 27/02; F28D 1/04; F28D 21/00; F28F 19/00

(52) U.S. Cl. CPC F28F 27/02; F28D 1/0417; F28F 19/00; F28D 2021/007; F28D 2021/0071; F28F 2265/18

(57) ABSTRACT

The present invention relates to a heat exchanger and a bypass valve used in the heat exchanger, which are provided in consideration of cooling/heating performance. An object of the present invention is to provide a heat exchanger, which adopts a variable path in consideration of cooling/heating performance to solve a problem in which cooling performance and heating performance vary depending on the number of paths, and a bypass valve used in the heat exchanger. More specifically, another object of the present invention is to provide a heat exchanger, which is designed to change the number of paths in consideration of cooling/heating performance so as to be optimized for performance in a cooling mode and performance in a heating mode, and a bypass valve used in the heat exchanger.

### TECHNICAL FIELD

The present disclosure relates to a heat exchanger and a bypass valve used in the heat exchanger, and more particularly, to a heat exchanger, which adopts a variable path in consideration of cooling/heating performance to solve a problem in which cooling performance and heating performance vary depending on the number of paths, and a bypass valve used in the heat exchanger.

### BACKGROUND ART

In general, not only components such as an engine for operating a vehicle are provided in an engine room of the vehicle, but also various heat exchangers such as a radiator, an intercooler, an evaporator, and a condenser for cooling the components such as the engine in the vehicle or adjusting an air temperature in an interior of the vehicle are provided in the engine room of the vehicle. In general, heat exchange media flow in the heat exchangers. The heat exchange medium in the heat exchanger exchanges heat with outside air present outside the heat exchanger, such that the cooling operation or the heat dissipation is performed.

A general refrigeration cycle essentially includes a condenser and an evaporator. The condenser is a heat exchanger responsible for condensation in a main refrigeration cycle in an air conditioning system for a vehicle and serves to condense a high-temperature, high-pressure gaseous refrigerant into a liquid state. The evaporator is a heat exchanger responsible for evaporation and serves to evaporate a liquid refrigerant to a gaseous refrigerant, unlike the condenser. In a general cooling mode, the condenser discharges condensation heat, which is generated as the refrigerant is condensed in the condenser, to the outside, whereas the refrigerant in the evaporator absorbs evaporation heat from the outside while being evaporated. The cooling operation is performed by blowing air around the evaporator into the interior by using a process in which the air around the evaporator is cooled by losing heat. Meanwhile, in a heating mode, in addition to a method of directly heating air, a method using a heat pump configured to blow air around the condenser into the interior is sometimes used by using the above-mentioned method in a reverse manner. The cooling mode and the heating mode are performed on the basis of substantially the same principle. A system is also widely used, in which the system is designed to change a flow direction of a refrigerant, and a single heat exchanger operates as an evaporator in the cooling mode and operates as a condenser in the heating mode, such that the cooling and heating operations may be performed by the single heat exchanger.

Meanwhile, the heat exchanger is generally shaped to include a plurality of tubes disposed in parallel with one another so that the refrigerant flows therethrough, and a pair of header tanks provided at two opposite ends of each of tube rows including the tubes. A shape of the heat exchanger, in which a flow of the refrigerant is most simple and easy, is a single route through which the refrigerant introduced into the single header tank performs heat exchange while passing through all the tube rows and is discharged through another header tank. The flow of the refrigerant in the heat exchanger also basically adopts the single route. However, the amount of pressure drop varies depending on a length of a refrigerant propagation route in the heat exchanger, which may cause various problems such as a problem in which a flow rate of the refrigerant cannot be uniformly distributed. Therefore, a design is widely introduced, in which the heat exchanger has two or four routes instead of the single route. For example, Korean Patent No. 2103951 (“Refrigerator,” Apr. 17, 2020) discloses a dual path condenser, and technologies of heat exchangers having multiple paths are variously publicly-known.

FIG. 1 illustrates a flow of a refrigerant in a four-path heat exchanger, and FIG. 2 illustrates a flow of a refrigerant in a two-path heat exchanger. Both the four-path/two-path heat exchangers 40 and 20 illustrated in FIGS. 1 and 2 each include a plurality of tubes 41 and 21 disposed in parallel with one another so that the refrigerant flows therethrough, and a pair of header tanks 42 and 22 provided at two opposite ends of each of tube rows including the tubes 41 and 21. The heat exchangers in FIGS. 1 and 2 are heat exchangers basically used as condensers, and a receiver dryer 10 is connected to the header tank 42 or 22 at one side. Inlet ports 43 and 23/outlet ports 44 and 24, through which the refrigerant is introduced/discharged, are provided in the header tanks 42 and 22. In addition, in order to implement a desired refrigerant flow direction, baffles 45 and 25 are provided at appropriate positions in the header tanks 41 and 21.

A flow of the refrigerant in the four-path heat exchanger 40 will be described specifically with reference to FIG. 1. As illustrated, the refrigerant introduced into the inlet port 43 is condensed in a stepwise manner while flowing in a ‘ [symbol] ’ shape sequentially along paths 1, 2, and 3. The refrigerant having passed through path 3 is introduced into the receiver dryer 10, and the gas and the liquid are separated. The liquid refrigerant separated by the receiver dryer 10 is introduced back into path 4 of the four-path heat exchanger 40. The refrigerant, which is overcooled while passing through path 4, is finally discharged to the outlet port 44.

A flow of the refrigerant in the two-path heat exchanger 20 will be described specifically with reference to FIG. 2. As illustrated, the refrigerant introduced into the inlet port 23 is condensed while passing through path 1. The refrigerant having passed through path 1 is introduced into the receiver dryer 10, and the gas and the liquid are separated. The liquid refrigerant separated by the receiver dryer 10 is introduced back into path 2 of the two-path heat exchanger 20. The refrigerant, which is overcooled while passing through path 2, is finally discharged to the outlet port 24.

In case that the four-path/two-path heat exchangers 40 and 20 in FIGS. 1 and 2 operate as condensers in the cooling mode, the four-path heat exchanger 40 has excellent heat transfer performance, a problem with high pressure in the system is solved, and power consumption of a compressor is reduced, such that a coefficient of performance (COP) of the system is improved. However, because the flow path structure of the two-path heat exchanger 20 is relatively simple, heat transfer performance is relatively low, and a problem with high pressure of the system occurs. Further, power consumption of the compressor is increased by the high pressure of the system, which consequently decreases the COP of the system. More specifically, it is known that in the cooling mode, a high pressure of about 4 bar or more is applied, and the COP decreases by about 8% in the two-path heat exchanger 20 in comparison with the four-path heat exchanger 40.

Meanwhile, as described above, a system is widely used in which the single heat exchanger operates as the condenser in the cooling mode and operates as the evaporator in the heating mode. However, in the cooling mode, the performance of the four-path heat exchanger 40 is much higher than the performance of the two-path heat exchanger 40, but in the heating mode, the opposite trend occurs. That is, in case that the four-path/two-path heat exchangers 40 and 20 operate as the evaporators in the heating mode, the flow rate of the refrigerant flowing in the system is low because of a complicated flow path structure of the four-path heat exchanger 40, which degrades the heating performance. In contrast, in the two-path heat exchanger 20, refrigerant flow resistance is low because of the simple flow path structure, and the flow rate of the refrigerant is relatively high, which improves the heating performance. More specifically, it is known that in the heating mode, the flow rate of the refrigerant is as high as 4 to 14 kg/hr, and a heating discharge temperature is high by about 1 to 3 degrees in the two-path heat exchanger 20 in comparison with the four-path heat exchanger 40.

As described above, in case that the single heat exchanger operates as the condenser in the cooling mode and operates as the evaporator in the heating mode, the current heat exchanger structure exhibits excellent performance in any one of the cooling and heating modes, whereas the heat exchanger structure has poor performance in the other of the cooling and heating modes. Accordingly, there is a need to develop a heat exchanger capable of exhibiting excellent performance in both the cooling and heating modes.

### DOCUMENT OF RELATED ART

### [Patent Document]

1. Korean Patent No. 2103951 (“Refrigerator,” Apr. 17, 2020)

### DISCLOSURE

### Technical Problem

The present invention has been made in an effort to solve the above-mentioned problem in the related art, and an object of the present invention is to provide a heat exchanger, which adopts a variable path in consideration of cooling/heating performance to solve a problem in which cooling performance and heating performance vary depending on the number of paths, and a bypass valve used in the heat exchanger. More specifically, another object of the present invention is to provide a heat exchanger, which is designed to change the number of paths in consideration of cooling/heating performance so as to be optimized for performance in a cooling mode and performance in a heating mode, and a bypass valve used in the heat exchanger.

### Technical Solution

In order to achieve the above-mentioned objects, the present invention provides a heat exchanger 100, which is provided in consideration of cooling and heating performance, the heat exchanger including: a plurality of tubes 110 disposed in parallel with one another and configured to define a core region in which a refrigerant flows; a pair of header tanks provided at two opposite ends of the tubes 110; and a plurality of baffles provided in the header tanks, in which a plurality of paths is formed and sequentially disposed in the core region by the plurality of baffles, and a bypass valve 160, which selectively bypasses at least some of the plurality of paths, communicates with at least any one side of the pair of header tanks.

In this case, the heat exchanger 100 may further include: a receiver dryer 200 configured to separate the refrigerant into a gaseous refrigerant and a liquid refrigerant, in which at least a part of the refrigerant, which is introduced the heat exchanger 100 when the bypass valve 160 is opened, flows through some of the plurality of paths, passes through the receiver dryer 200, and then is discharged.

In addition, the bypass valve 160 may be disposed at an upstream side of the receiver dryer 200 based on a flow of the refrigerant.

In addition, the heat exchanger 100 may include: a bypass port 131 provided in the header tank; and a bypass path 132 connected to the bypass valve 160 and configured to allow the refrigerant to bypass the path when the bypass path is opened.

In addition, in the heat exchanger 100, the number of paths in the core region may be four.

In addition, the bypass valve 160 may be opened or closed in accordance with a temperature.

In this case, the heat exchanger 100 may serve as a condenser and close the bypass valve 160 in a cooling mode, and the heat exchanger 100 may serve as an evaporator and open the bypass valve 160 in a heating mode.

In the heat exchanger 100 in the first embodiment, when the bypass valve 160 is closed, the entire refrigerant introduced into the heat exchanger 100 may pass through all the paths in the core region and then be discharged to the outside of the heat exchanger 100. When the bypass valve 160 is opened, at least a part of the refrigerant introduced into the heat exchanger 100 may be discharged to the outside of the heat exchanger 100 without passing through at least one path in the core region.

In this case, the bypass valve 160 may be provided in a flange block BLK having the inlet port 130 that communicates with the header tank.

In addition, in the heat exchanger 100, when the bypass valve 160 is opened, the refrigerant, which flows all the paths positioned at the upstream side of the receiver dryer 200, and the refrigerant, which is introduced through the opened bypass valve 160 and flows through the bypass path 132, may merge with each other and pass through the receiver dryer 200.

In the heat exchanger in the second and third embodiments, the refrigerant may pass through the receiver dryer 200 when the bypass valve 160 is closed, and the refrigerant may not pass through the receiver dryer 200 when the bypass valve 160 is opened.

In this case, the bypass valve 160 may be provided between inlet and outlet ports 130 and 140 formed in the header tank.

In addition, in the heat exchanger 100, the bypass valve 160 may be connected to the outlet port 140, and the refrigerant may pass only through the path, which is positioned at an upstream side of the bypass valve 160 in the core region, and be discharged through the outlet port 140 when the bypass valve 160 is opened.

In addition, in the heat exchanger 100, the pair of header tanks may be spaced apart from each other leftward and rightward such that the tubes 100 are disposed horizontally as in the second embodiment, or the pair of header tanks may be spaced apart from each other in an upward/downward direction such that the tubes 100 are disposed vertically as in the third embodiment.

In addition, the present invention provides a bypass valve 160, which is provided in the heat exchanger 100 and configured to be opened and closed in accordance with a temperature of a refrigerant to allow the refrigerant to bypass when the bypass valve is opened, the bypass valve 160 including: a first communication path 161 connected to the heat exchanger and configured to allow the refrigerant to flow therethrough; a second communication path 162 connected to a bypass route of the heat exchanger and configured to allow the refrigerant to flow therethrough; a main space portion 163 configured to communicate with the inlet port 130 and the first communication path 161 and configured to accommodate a valve part configured to perform opening and closing operations; and a sub-space portion 164 configured to communicate with the main space portion 163 and having a smaller cross-sectional area than the main space portion 163, in which the communication between the sub-space portion and the main space portion 163 is opened or closed by an operation of the valve part, and the sub-space portion communicates with the second communication path 162.

In this case, the valve part may include: a guide pin 171 extending in an extension direction of the main space portion 163 and provided in the main space portion 163; a valve cap 172 configured to fix one side of the guide pin 171 to one side of the main space portion 163; a casing 173 formed in a container shape opened at one end thereof and configured to accommodate the guide pin 171, the casing having an inner wall spaced apart from an outer surface of the guide pin; an elastic portion 174 provided to surround the guide pin 171; a cover part 175 configured to be movable along the guide pin 171 and configured to seal an open end of the casing 173; a wax portion 176 configured to fill a space between the elastic portion 174 and the casing 173 and configured to be changed in phase to a liquid or solid phase in accordance with a temperature; and a valve plate 177 provided at the other side of the casing 173 and configured to open or close communication between the main space portion 163 and the sub-space portion 164.

In addition, in the valve part, in a cooling mode, the refrigerant has a relatively high temperature, the wax portion 176 changes in phase to a liquid phase, and a volume is increased, such that the wax portion presses the elastic portion 174, the guide pin 171 receives a squeezing force by being pressed by the elastic portion 174, such that the casing 173 moves, and the valve plate 177 closes the communication between the main space portion 163 and the sub-space portion 164, and in a heating mode, the refrigerant has a relatively low temperature, the wax portion 176 changes in phase to a solid phase, and a volume is decreased, such that the casing 173 is restored to an original position, and the valve plate 177 opens the communication between the main space portion 163 and the sub-space portion 164.

In addition, the valve part may include: a main spring 178 having two opposite ends respectively supported by the valve plate 177 and one side of the casing 173 and configured to absorb excessive expansion of the wax portion 176; and a restoring spring 179 having two opposite ends respectively supported by the valve plate 177 and the other side of the sub-space portion 164 and configured to assist in restoring the casing 173 to the original position.

In addition, in the valve part, the casing 173 may be made of a metallic material.

### Advantageous Effects

According to the present invention, the heat exchanger is designed such that the number of paths is changed, as necessary, which may basically solve the problem in which the cooling performance and the heating performance vary depending on the number of paths. In more detail, the four-path/two-path heat exchangers are widely used in the related art. The four-path heat exchanger exhibits excellent performance when the four-path heat exchanger is used as the condenser, and the two-path heat exchanger exhibits excellent performance when the two-path heat exchanger is used as the evaporator.

In addition, in the present invention, the thermal bypass valve is used to change the refrigerant path by sensing the refrigerant temperature, such that the paths optimized for the cooling and heating modes may be formed. Therefore, it is possible to simply change the heat exchanger path without using a separate electrical signal and electric power and implement the excellent performance in both the cooling and heating modes.

### DESCRIPTION OF DRAWINGS

FIG. 1 is a view illustrating a flow of a refrigerant in a four-path heat exchanger.

FIG. 2 is a view illustrating a flow of a refrigerant in a two-path heat exchanger.

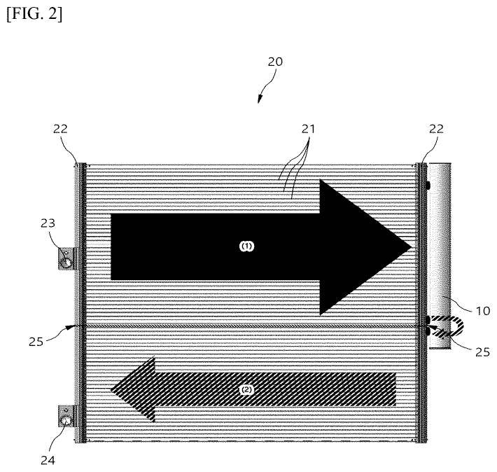

FIG. 3 is a view illustrating a first embodiment of a heat exchanger of the present invention.

FIG. 4 is a view illustrating a flow of a refrigerant in the first embodiment of the heat exchanger of the present invention in a cooling mode.

FIG. 5 is a view illustrating a flow of the refrigerant in the first embodiment of the heat exchanger of the present invention in a heating mode.

FIG. 6 is a view illustrating a second embodiment of the heat exchanger of the present invention.

FIG. 7 is a view illustrating a flow of the refrigerant in the second embodiment of the heat exchanger of the present invention in the cooling mode.

FIG. 8 is a view illustrating a flow of the refrigerant in the second embodiment of the heat exchanger of the present invention in the heating mode.

FIG. 9 is a view illustrating a third embodiment of the heat exchanger of the present invention.

FIG. 10 is a view illustrating a flow of the refrigerant in the third embodiment of the heat exchanger of the present invention in the cooling mode.

FIG. 11 is a view illustrating a flow of the refrigerant in the third embodiment of the heat exchanger of the present invention in the heating mode.

FIG. 12 is a view illustrating an operational principle of a thermal valve.

FIG. 13 is a cross-sectional view of a first embodiment of a bypass valve of the present invention.

FIG. 14 is a perspective view illustrating an operation of the first embodiment of the bypass valve in the cooling mode.

FIG. 15 is a perspective view illustrating an operation of the first embodiment of the bypass valve in the heating mode.

FIG. 16 is a cross-sectional view illustrating an operation of a second embodiment of the bypass valve in a cooling/heating mode.

Description of Reference Numerals

| | |
|---|---|
| 100: Heat exchanger, | 110: Tube |
| 121: First header tank, | 122: Second header tank |
| 130: Inlet port, | 140: Outlet port |
| 131: Bypass port, | 132: Bypass path |
| 151: First baffle, | 152: Second baffle |
| 153: Third baffle, | 154: Fourth baffle |
| 160: Bypass valve | |
| 161: First communication path, | 162: Second communication path |
| 163: Main space portion, | 164: Sub-space portion |
| 171: Guide pin, | 172: Valve cap |
| 172a: Seal ring, | 172b: Snap ring |
| 173: Casing, | 174: Elastic portion |
| 175: Cover part, | 175a: Sealing plate |
| 176: Wax portion | |
| 177: Valve plate, | 177a: Fixing ring |
| 178: Main spring, | 179: Sub-spring |

### MODE FOR INVENTION

Hereinafter, a heat exchanger and a bypass valve used in the heat exchanger according to the present invention configured as described above in consideration of cooling/heating performance will be described in detail with reference to the accompanying drawings.

### [1] Heat Exchanger of Present Invention

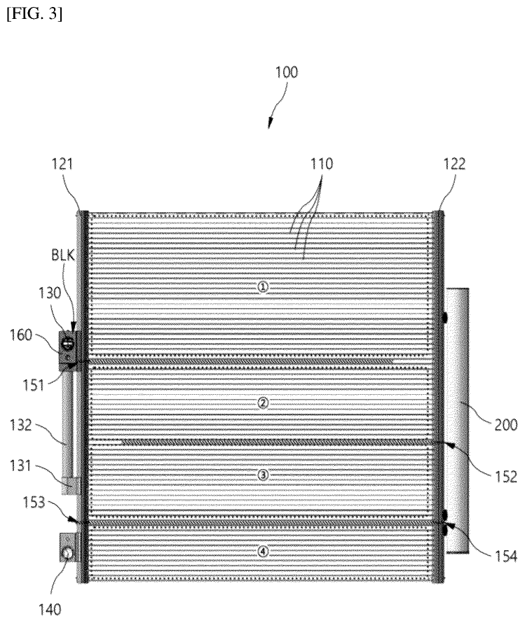

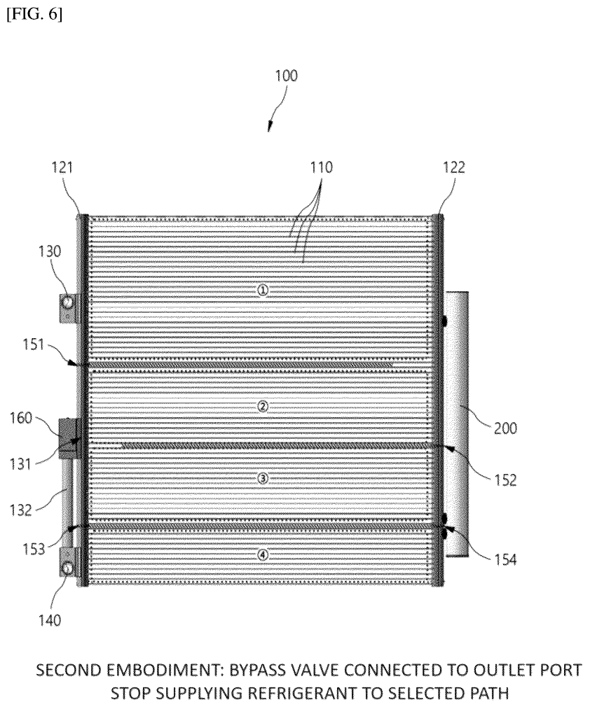

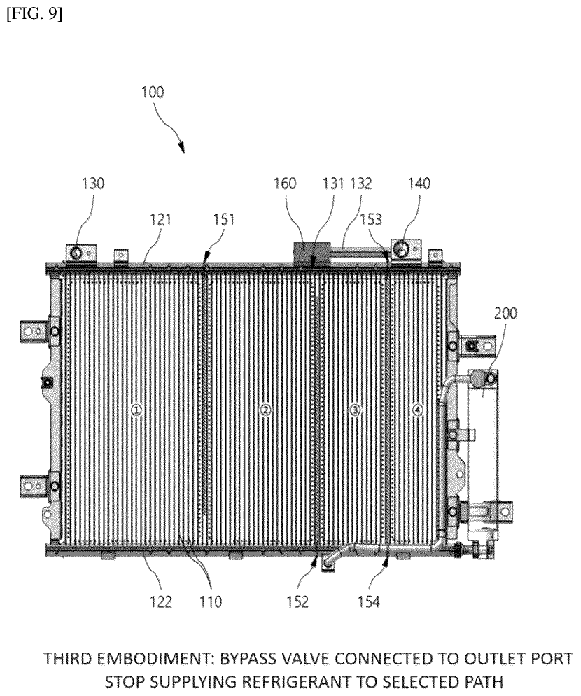

FIG. 3 illustrates a first embodiment of a heat exchanger of the present invention, FIG. 6 illustrates a second embodiment of the heat exchanger of the present invention, and FIG. 9 illustrates a third embodiment of the heat exchanger of the present invention. First, the first, second, and third embodiments are different in positions of a bypass valve 160. The first, second, and third embodiments will be described below in more detail. A basic configuration of a heat exchanger 100 of the present invention will be described first.

The heat exchanger 100 of the present invention basically has a configuration similar to a four-path heat exchanger. That is, the heat exchanger 100 includes a plurality of tubes 110 disposed in parallel with one another and configured to define a core region in which a refrigerant flows, a pair of header tanks provided at two opposite ends of the tubes 110, and a plurality of baffles provided in the header tanks, and a plurality of paths is sequentially disposed and formed the core region by the plurality of baffles.

As described above, in case that the four-path heat exchanger operates as a condenser in a cooling mode, the four-path heat exchanger has excellent performance in comparison with the two-path heat exchanger. However, in case that the four-path heat exchanger operates as an evaporator in a heating mode, the performance deteriorates because of a complicated route. In view of this configuration, in the present invention, the heat exchanger 100 operates as the four-path heat exchanger in the cooling mode. In contrast, in the heating mode, the bypass valve 160 is used to allow a part of the refrigerant to flow to a simpler route, which solves a problem with the complexity of a route in the four-path heat exchanger in the related art. That is, in the heat exchanger 100 of the present invention, the bypass valve 160, which selectively bypasses at least some of the plurality of paths, communicates with at least any one side of the pair of header tanks. Particularly, in this case, the bypass valve 160 may be opened or closed in accordance with a temperature. Functionally, in the present invention, in the cooling mode, the heat exchanger 100 serves as the condenser, and the bypass valve 160 is closed. In the heating mode, the heat exchanger 100 serves as the evaporator, and the bypass valve 160 is opened.

The heat exchanger 100 may further include a receiver dryer 200 configured to separate the refrigerant into a gaseous refrigerant and a liquid refrigerant. In this case, the bypass valve 160 may be disposed at an upstream side of the receiver dryer 200 based on the flow of the refrigerant.

In addition, as described below in more detail, the heat exchanger 100 may include a bypass port 131 provided in the header tank, and a bypass path 132 connected to the bypass valve 160 configured to be opened to allow the refrigerant to bypass the path. The position of the bypass port 131 and the position of the bypass path 132 vary depending on the embodiments. The position of the bypass port 131 and the position of the bypass path 132 will be described in more detail when the embodiments will be described.

Meanwhile, as in the first and second embodiments illustrated in FIGS. 3 and 6, the heat exchanger 100 may be formed in a shape in which a pair of header tanks is spaced apart from each other leftward and rightward, and the tubes 110 are disposed horizontally. As in the third embodiment illustrated in FIG. 9, a pair of header tanks is spaced apart from each other in an upward/downward direction, and the tubes 110 are disposed vertically.

In the present invention, the number of paths in the core region of the heat exchanger 100 is four. The configuration of the heat exchanger 100 will be more specifically described below in detail. One of the pair of header tanks will be referred to as a first header tank 121, and the remaining header tank will be referred to as a second header tank 122. The first header tank 121 has an inlet port 130 into which the refrigerant is introduced, and an outlet port 140 from which the refrigerant is discharged. In addition, first and third baffles 151 and 153 are provided in the first header tank 121, and second and fourth baffles 152 and 154 are provided in the second header tank 122. The first, second, third baffles 151, 152, and 153 are provided at positions sequentially spaced apart from one another and define first, second, and third paths \textcircled{1}, \textcircled{2}, and \textcircled{3}, and the third and fourth baffles 153 and 154 are provided at the same position and define a fourth path \textcircled{4}. That is, the core region is divided by the baffles, and the first, second, third, and fourth paths \textcircled{1}, \textcircled{2}, \textcircled{3}, and \textcircled{4} are sequentially disposed. Meanwhile, the receiver dryer 200 is connected to any one header tank, receives the refrigerant having passed through the first, second, and third paths \textcircled{1}, \textcircled{2}, and \textcircled{3}, separates the refrigerant into a gaseous refrigerant and a liquid refrigerant, and discharges the liquid refrigerant to the fourth path \textcircled{4}.

More clearly, the first baffle 151 may be provided in the first header tank 121 and provided at a position between the inlet port 130 and the outlet port 140. The second baffle 152 is provided in the second header tank 122 and provided at a position between the first baffle 151 and the outlet port 140. The third baffle 153 is provided in the first header tank 121 and provided at a position between the second baffle 152 and the outlet port 140. The fourth baffle 154 is provided in the second header tank 122 is provided at the same position as the third baffle 153. Therefore, a region separated by the first baffle 151 defines the first path \textcircled{1}, a region between the first baffle 151 and the second baffle 152 defines the second path \textcircled{2}, and a region between the second baffle 152 and the third and fourth baffles 153 and 154 defines the third path \textcircled{3}, such that the refrigerant defines a ‘ [symbol] ’ shape while sequentially passing through the first, second, and third paths \textcircled{1}, \textcircled{2}, and \textcircled{3}. A region separated by the third and fourth baffles 153 and 154 defines the fourth path \textcircled{4}. That is, the fourth path \textcircled{4} is substantially completely isolated from the first, second, and third paths \textcircled{1}, \textcircled{2}, and \textcircled{3}. Meanwhile, the inlet port 130 is formed at a position that communicates with the first path \textcircled{1}, and the outlet port 140 is formed at a position that communicates with the fourth path \textcircled{4}. In this case, because the receiver dryer 200 connects the third path \textcircled{3} and the fourth path \textcircled{4}, the refrigerant may be introduced into the inlet port 130, sequentially pass through the first, second, and third paths \textcircled{1}, \textcircled{2}, and \textcircled{3}, the receiver dryer 200, and the fourth path \textcircled{4}, and be smoothly discharged through the outlet port 140.

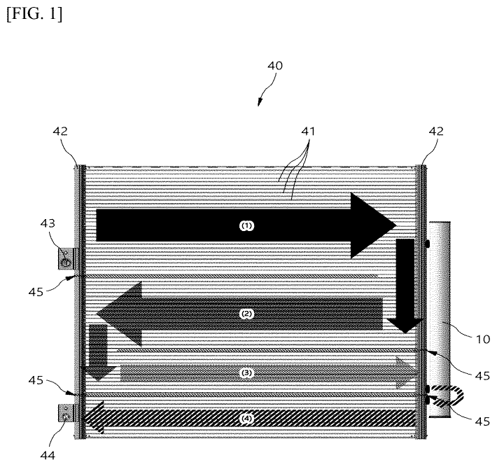

This configuration is substantially identical to the configuration of the flow path of the four-path heat exchanger 40 described with reference to FIG. 1. However, in the present invention, as described above, the bypass valve 160 may be used to allow the refrigerant to flow to the four paths in an intact manner or appropriately bypass the four paths in accordance with the cooling and heating modes, such that the performance in the both mode may be improved.

A difference in functions of the bypass valve 160 between the first, second, and third embodiments will be described in more detail.

In the first embodiment, when the bypass valve 160 is closed, the entire refrigerant introduced into the heat exchanger 100 passes through all the paths in the core region and then is discharged to the outside of the heat exchanger 100. When the bypass valve 160 is opened, at least a part of the refrigerant introduced into the heat exchanger 100 is discharged to the outside of the heat exchanger 100 without passing through at least one path in the core region. In this case, the bypass valve 160 is provided in a flange block BLK having the inlet port 130 that communicates with the header tank. More specifically, when the bypass valve 160 is opened, the refrigerant (hereinafter, referred to as an ‘additional refrigerant’), which is additionally introduced through the opened bypass valve 160, additionally passes through the third and fourth paths \textcircled{3} and \textcircled{4}. Therefore, when the bypass valve 160 is opened, the refrigerant, which flows all the paths positioned at the upstream side of the receiver dryer 200, and the refrigerant, which is introduced through the opened bypass valve 160 and flows through the bypass path 132, merge with each other and pass through the receiver dryer 200. That is, in the first embodiment, the problem of an insufficient flow rate of the refrigerant is solved by an additional supply of the refrigerant.

In the second and third embodiments, the refrigerant passes through the receiver dryer 200 when the bypass valve 160 is closed, and the refrigerant does not pass through the receiver dryer 200 when the bypass valve 160 is opened. In this case, the bypass valve 160 is provided between the inlet port 130 and the outlet port 140, and the bypass valve 160 is connected to the outlet port 140, such that the refrigerant may be smoothly discharged while the refrigerant flows. More specifically, when the bypass valve 160 is opened, the refrigerant is supplied to pass only through the first and second paths \textcircled{1} and \textcircled{2}. Therefore, when the bypass valve 160 is opened, the refrigerant passes only through the path positioned at the upstream side of the bypass valve 160 in the core region and then is discharged through the outlet port 140. That is, in the second and third embodiments, the problem of an insufficient flow rate of the refrigerant is solved by simplifying the route.

That is, in all the first, second, and third embodiments, when the bypass valve 160 is closed, the bypass valve 160 supplies the refrigerant so that the refrigerant passes through all the first, second, third, and fourth paths \textcircled{1}, \textcircled{2}, \textcircled{3}, and \textcircled{4}. When the refrigerant is supplied to the first path \textcircled{1}, the refrigerant naturally passes through all the first, second, third, and fourth paths \textcircled{1}, \textcircled{2}, \textcircled{3}, and \textcircled{4}. Therefore, in this case, it can be said that the heat exchanger operates as the four-path heat exchanger. Meanwhile, when the bypass valve 160 is opened, the flow of the refrigerant is implemented in the two types of embodiments, as described above. That is, specifically, the bypass valve 160 supplies the refrigerant so that the refrigerant additionally passes through two paths selected from the first, second, third, and fourth paths \textcircled{1}, \textcircled{2}, \textcircled{3}, and \textcircled{4} (first embodiment) or passes only through the two selected paths (second and third embodiments). In this case, in both the two types of embodiments, a physical distance is present between the bypass valve 160 and a desired path position. Therefore, in order to supply the refrigerant smoothly, the heat exchanger 100 further includes the bypass port 131 provided in the first header tank 121, and the bypass path 132 connected to the bypass valve 160 and configured to allow the refrigerant to bypass the path when the bypass path 132 is opened.

In this case, the position of the bypass port 131 and the connection relationship of the bypass path 132 slightly vary depending on the embodiments. Specifically, in the first embodiment, the bypass port 131 is formed at the position that communicates with the third path \textcircled{3} on the first header tank 121, and the bypass path 132 connects the bypass valve 160 and the bypass port 131 (see FIG. 3). In addition, in the second and third embodiments, the bypass port 131 is formed at the position that communicates with the second path \textcircled{2} on the first header tank 121, and the bypass path 132 connects the bypass valve 160 and the outlet port 140 (see FIGS. 6 and 9).

Hereinafter, how to optimize the flow of the refrigerant in the cooling mode and the heating mode will be more specifically described in detail. As briefly described above, in the heat exchanger 100 of the present invention, the flow path configuration is designed on the basis that the performance of the four-path heat exchanger is good in the cooling mode, and the performance of the two-path heat exchanger is good in the heating mode. That is, in the cooling mode, the heat exchanger 100 operates as the four-path heat exchanger. In the heating mode, in order to cope with the problem, which occurs when the four-path heat exchanger is used for the heating process, i.e., the problem of an insufficient flow rate of the refrigerant, the refrigerant is additionally supplied (first embodiment) or the heat exchanger 100 operates as the two-path heat exchanger (second and third embodiments).

First, the first embodiment will be described in detail. In the first embodiment, as described above, the problem of an insufficient flow rate of the refrigerant is solved by an additional supply of the refrigerant.

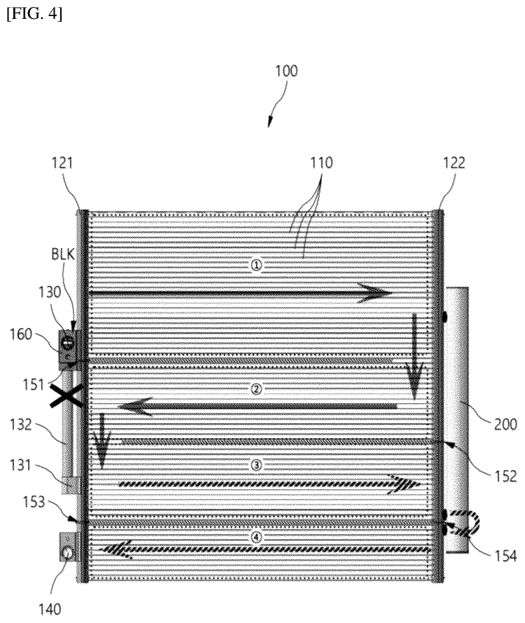

FIG. 4 illustrates a flow of the refrigerant in the first embodiment of the heat exchanger of the present invention in the cooling mode. In the heat exchanger 100 of the present invention in the first embodiment, the heat exchanger 100 operates as the condenser in the cooling mode, the bypass valve 160 is closed, and the refrigerant is supplied only to the first path \textcircled{1}, such that the refrigerant passes through all the first, second, third, and fourth paths \textcircled{1}, \textcircled{2}, \textcircled{3}, and \textcircled{4}. Therefore, as illustrated in FIG. 4, the refrigerant sequentially passes through the first, second, third, and fourth paths \textcircled{1}, \textcircled{2}, \textcircled{3}, and \textcircled{4}. This flow of the refrigerant is identical to the flow of the refrigerant of the four-path heat exchanger described with reference to FIG. 1. As described above, it is known that the performance is much better when the four-path heat exchanger operates as the condenser (“in the cooling mode, a high pressure of about 4 bar or more is applied, and the COP decreases by about 8% in the two-path heat exchanger 20 in comparison with the four-path heat exchanger 40”). Therefore, in the cooling mode, the heat exchanger 100 generates a flow of the refrigerant identical to the flow of the refrigerant in the general four-path heat exchanger.

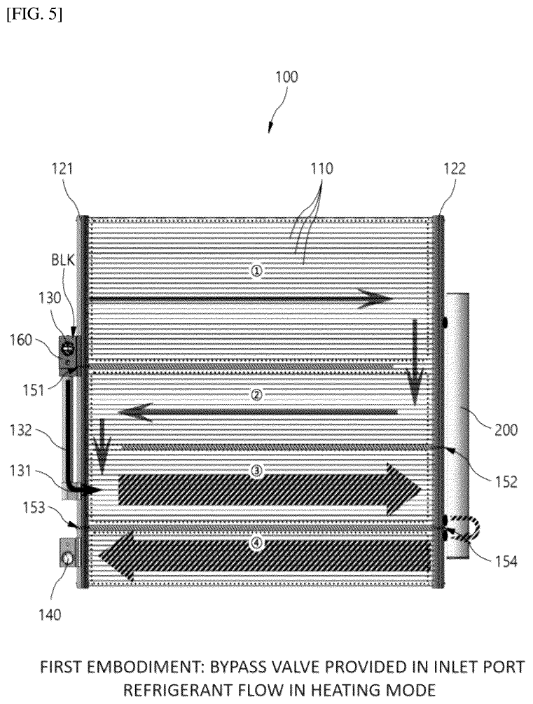

FIG. 5 illustrates a flow of the refrigerant in the first embodiment of the heat exchanger of the present invention in the heating mode. In the heat exchanger 100 of the present invention in the first embodiment, the heat exchanger 100 operates as the evaporator in the heating mode, the bypass valve 160 is opened, and the refrigerant is supplied to the first path \textcircled{1} and the third path \textcircled{3}, such that the refrigerant additionally passes through the third and fourth paths \textcircled{3} and \textcircled{4}. Therefore, as illustrated in FIG. 5, a part of the refrigerant sequentially passes through the first, second, and third paths \textcircled{1}, \textcircled{2}, and \textcircled{3}, and the remaining of the refrigerant passes only through the third path \textcircled{3}. As a result, the refrigerant with a flow rate, which corresponds to a flow rate made by adding up two flow rates, passes through the fourth path \textcircled{4}. As described above, in case that the four-path heat exchanger operates as the evaporator, the flow rate of the refrigerant is low because of the complexity of the flow path, and the heating performance deteriorates (“it is known that in the heating mode, the flow rate of the refrigerant is as high as 4 to 14 kg/hr, and a heating discharge temperature is high by about 1 to 3 degrees in the two-path heat exchanger 20 in comparison with the four-path heat exchanger 40”). However, in the heat exchanger 100 of the present invention, in the heating mode, only a part of the refrigerant introduced into the inlet port 130 passes through the complicated flow paths (the first, second, third, and fourth paths), and the remaining part of the refrigerant passes through the simple flow path (the third and fourth paths). That is, the refrigerant may be additionally supplied to pass through the third and fourth paths. As a result, the flow rate of the refrigerant, which flows entirely, may be increased in comparison with the four-path heat exchanger in the related art. Therefore, the problem of an insufficient flow rate of the refrigerant, which causes the deterioration in heating performance in the four-path heat exchanger in the related art, may be solved, such that the performance may be further improved even in the heating mode.

Next, the second and third embodiments will be described in detail. In the second and third embodiments, the problem of an insufficient flow rate of the refrigerant is solved by simplifying the route.

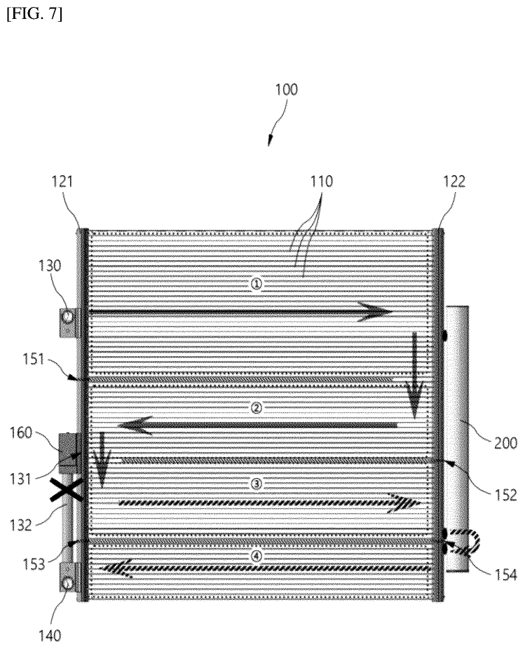

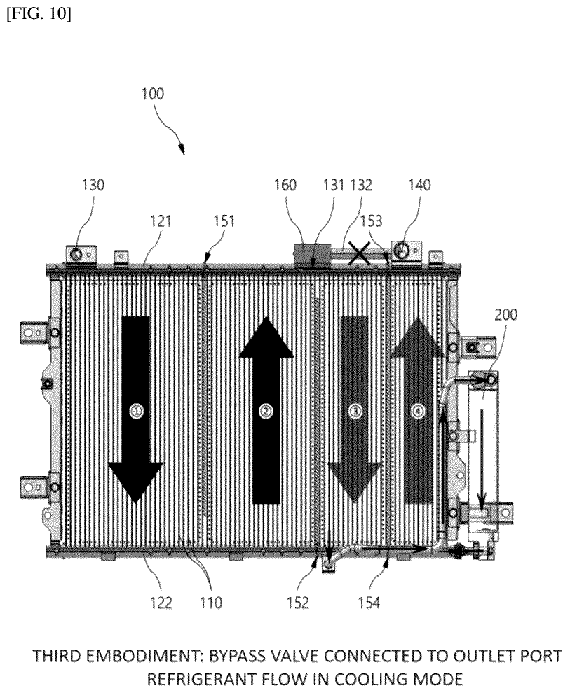

FIGS. 7 and 10 illustrate flows of the refrigerant in the second and third embodiments of the heat exchanger of the present invention in the cooling mode. As in the first embodiment, in the heat exchanger 100 of the present invention in the second and third embodiments, the heat exchanger 100 operates as the condenser in the cooling mode, the bypass valve 160 is closed, and the refrigerant is supplied only to the first path \textcircled{1}, such that the refrigerant passes through all the first, second, third, and fourth paths \textcircled{1}, \textcircled{2}, \textcircled{3}, and \textcircled{4}. Therefore, as illustrated in FIGS. 7 and 10, the refrigerant sequentially passes through the first, second, third, and fourth paths \textcircled{1}, \textcircled{2}, \textcircled{3}, and \textcircled{4}. This flow of the refrigerant is identical to the flow of the refrigerant in the four-path heat exchanger described with reference to FIG. 1 (and the flow of the refrigerant in the cooling mode in the first embodiment described with reference to FIG. 4).

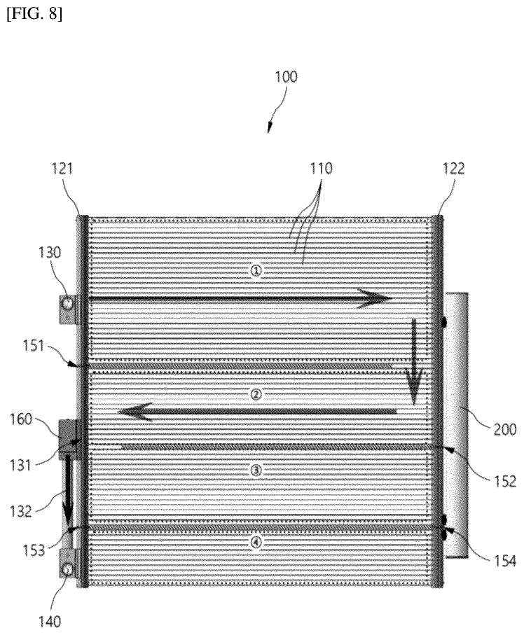

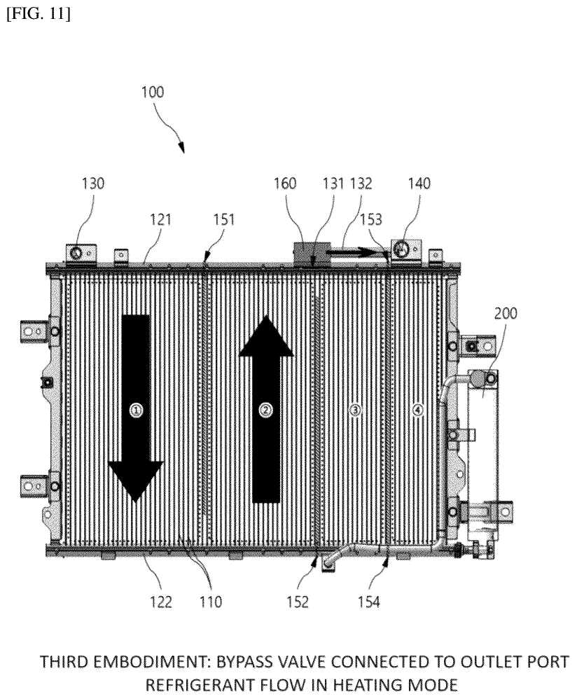

FIGS. 8 and 11 illustrate flows of the refrigerant in the second and third embodiments of the heat exchanger of the present invention in the heating mode. In the heat exchanger 100 of the present invention in the second and third embodiments, the heat exchanger 100 operates as the evaporator in the heating mode, the bypass valve 160 is opened, and the refrigerant having passed through the first and second paths \textcircled{1} and \textcircled{2} is immediately discharged, such that the refrigerant passes only through the first and second paths \textcircled{1} and \textcircled{2}. Therefore, as a result, as illustrated in FIGS. 8 and 11, the refrigerant is discharged while passing only through the first and second paths \textcircled{1} and \textcircled{2} and does not pass through the third and fourth paths \textcircled{3} and \textcircled{4}, such that the refrigerant does not flow to the receiver dryer 200. The receiver dryer 200 serves to separate the gaseous refrigerant and the liquid refrigerant when the heat exchanger 100 operates as the condenser. Therefore, the receiver dryer 200 does not perform a meaningful operation anyway in the heating mode in which the heat exchanger 100 substantially operates as the evaporator. Therefore, even though the path, which passes through the receiver dryer 200, is excluded, the performance does not deteriorate, and the passage of the unnecessary device is reduced, which assists in improving the amount of pressure drop. Of course, a small amount of refrigerant may actually flow to the third and fourth paths \textcircled{3} and \textcircled{4}, but a flow rate of the refrigerant is very low and does not affect the overall performance. As described above, according to the second embodiment, the refrigerant flow path is simplified, and the amount of pressure drop of the refrigerant is further improved. As a result, the flow rate of the refrigerant, which flows entirely, may be increased in comparison with the four-path heat exchanger in the related art. Therefore, the problem of an insufficient flow rate of the refrigerant, which causes the deterioration in heating performance in the four-path heat exchanger in the related art, may be solved, such that the performance may be further improved even in the heating mode.

More specifically, as illustrated in FIGS. 6, 7, and 8, in the heat exchanger 100 in the second embodiment, the first and second header tanks 121 and 122 are spaced apart from each other leftward and rightward, and the tubes 110 are disposed horizontally. As illustrated in FIGS. 9, 10, and 11, in the heat exchanger 100 in the third embodiment, the first and second header tanks 121 and 122 are spaced apart from each other in the upward/downward direction, and the tubes 110 are disposed vertically. In both the two cases, the flows of the refrigerant in the cooling mode and the heating mode are equally implemented. However, the refrigerant flow direction varies in the horizontal direction and the vertical direction. In the second embodiment, the first header tank 121 stands vertically. Therefore, before the refrigerant discharged from the second path \textcircled{2} is introduced into the bypass valve 160, the refrigerant is moved downward by gravity, and a small amount of refrigerant may leak to the third path \textcircled{3}. Meanwhile, in the third embodiment, the first header tank 122 lies horizontally, and particularly, is disposed at the upper side. Therefore, as in the second embodiment, before the refrigerant discharged from the second path \textcircled{2} is introduced into the bypass valve 160, the refrigerant is moved downward by gravity, and a small amount of refrigerant may leak to the third path \textcircled{3}. However, in both the embodiments, in case that the refrigerant has a sufficiently high pressure and flow rate, only a negligible amount of leakage occurs, which is not considered important.

### [2] Detailed Configuration of Bypass Valve of Present Invention

As described with reference to paragraph [1], in the heat exchanger 100 of the present invention, the paths are changed as the bypass valve 160 is opened or closed in accordance with the modes, such that the path optimized for each of the modes is formed. In this case, the bypass valve 160 may be equipped with an electronic circuit, and a control signal may be applied to adjust the opening or closing of the bypass valve 160. However, in the present invention, the opening or closing of the bypass valve 160 may be mechanically adjusted in accordance with a temperature of the refrigerant, such that unnecessary components and control algorithm may be additionally removed, which further improves the system efficiency.

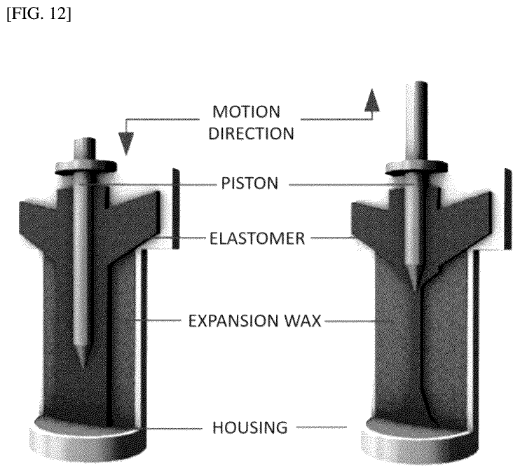

First, the operational principle of the valve, which is opened or closed in accordance with the temperature, will be briefly described. FIG. 12 is a view for explaining an operational principle of a thermal valve. As illustrated in FIG. 12, the thermal valve has a shape in which a piston is provided in a housing and surrounded by an elastomer, and a space between the housing and the elastomer is filled with expansion wax. The expansion wax changes into a liquid or solid phase depending on the temperature, with the expansion wax existing as a solid at low temperatures and having a small volume. The left view in FIG. 12 illustrates a state of the thermal valve at a low temperature. Meanwhile, when the temperature environment is raised to a higher temperature, the expansion wax changes to a liquid phase and increases in volume. Because the volume of space in the housing is fixed, any increase in the volume of the expansion wax exerts pressure on the elastomer. This pressure applied to the elastomer causes the piston, which is embedded in the elastomer, to “squeeze”. Therefore, as illustrated in the right view in FIG. 12, the piston is moved in a direction in which the piston is pushed to the outside of the housing. When the temperature environment is lowered to a low temperature again, the expansion wax decreases in volume and naturally returns to the state illustrated in the left view in FIG. 12.

When the piston end is designed to block any flow path hole in the state illustrated in the right view in FIG. 12, the thermal valve in FIG. 12 may operate to close the flow path hole at a high temperature and open the flow path hole at a low temperature. Of course, the flow path may be designed in another way, such that the flow path may be opened at a high temperature, and the flow path may be closed at a low temperature. In this way, the thermal valve does not require any electronic circuitry or control signals, and is able to regulate opening and closing based on purely mechanical principles using only the ambient temperature environment.

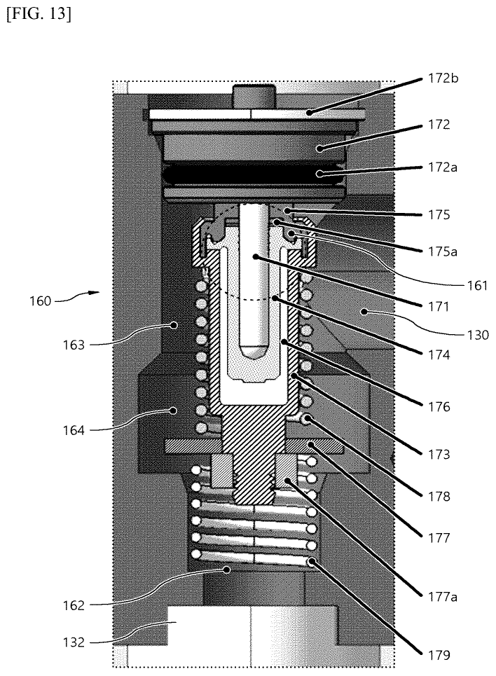

FIG. 13 is a cross-sectional view of the bypass valve of the present invention. First, more specifically, the bypass valve 160 according to the first embodiment is illustrated in FIGS. 13 to 15 illustrating that the inlet port 130 is formed on the bypass valve 160. However, in the second embodiment, the inlet port 130 is not formed in the bypass valve 160. Therefore, it is to be understood that the inlet port 130 is excluded from the drawings.

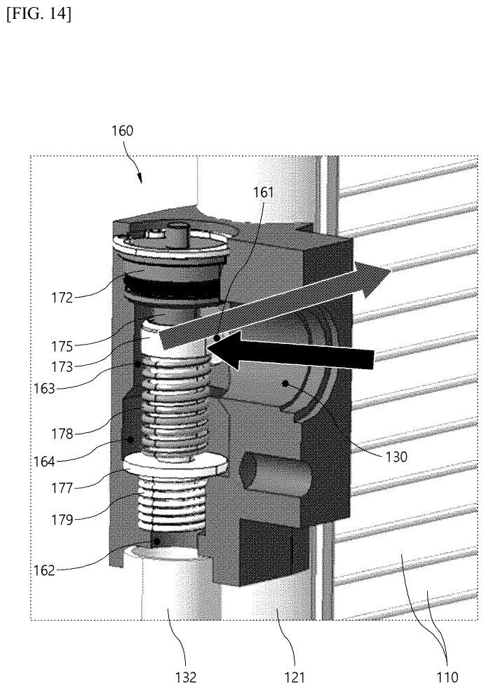

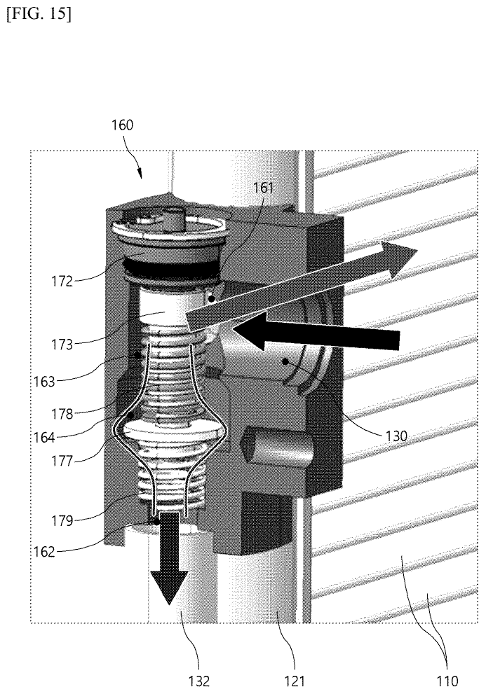

The principle of the thermal valve described with reference to FIG. 12 is applied to the bypass valve 160 of the present invention illustrated in FIG. 13, such that the opening and closing may be adjusted only on the basis of the purely mechanical principle. That is, the bypass valve 160 is configured to be opened or closed in accordance with the temperature of the refrigerant. Therefore, the bypass valve is closed when the refrigerant has a relatively high temperature in the cooling mode, and the bypass valve is opened when the refrigerant has a relatively low temperature in the heating mode. First, the configuration of the bypass valve 160 will be described in detail with reference to FIG. 13, and then the motions of the components when the bypass valve 160 is opened or closed will be described in detail with reference to FIGS. 14 and 15.

As illustrated in FIG. 13, the bypass valve 160 is provided in the heat exchanger 100 and receives the refrigerant, and the bypass valve 160 includes a first communication path 161 and a second communication path 162 to separate and discharge the refrigerant, as necessary. The first communication path 161 is connected to the heat exchanger 100 so that the refrigerant flows therethrough, and the second communication path 162 is connected to the bypass route of the heat exchanger 100 so that the refrigerant flows therethrough. FIG. 13 illustrates the bypass valve 160 used in the first embodiment. The first communication path 161 is connected to the bypass port 131 formed in the first header tank 121, and the second communication path 162 is connected to the bypass path 132. As described above, in the present invention, in the cooling mode, the bypass valve 160 is closed so that the refrigerant passes through all the first, second, third, and fourth paths \textcircled{1}, \textcircled{2}, \textcircled{3}, and \textcircled{4}. In the heating mode, the bypass valve 160 is opened so that the refrigerant is supplied to the first path \textcircled{1} and the third path \textcircled{3} in the first embodiment or the refrigerant having passed through the first and second paths \textcircled{1} and \textcircled{2} is immediately discharged in the second and third embodiments. That is, the first communication path 161 is always opened, and the second communication path 162 is formed to be opened or closed, as necessary.

To this end, first, a main space portion 163 and a sub-space portion 164 are formed in the bypass valve 160. The main space portion 163 communicates with the inlet port 130 and the first communication path 161 and accommodates a valve part configured to perform the opening and closing operations. The sub-space portion 164 basically communicates with the main space portion 163 and has a smaller cross-sectional area than the main space portion 163. That is, as illustrated in FIG. 13, a stepped portion is formed on a connection portion between the main space portion 163 and the sub-space portion 164, and the valve part is configured to open or close this portion. That is, the communication between the sub-space portion 164 and the main space portion 163 is opened or closed by the operation of the valve part. In this case, because the sub-space portion 164 communicates with the second communication path 162, the opening or closing of the second communication path 162 is adjusted by the operation of the valve part.

The valve part adopts the operational principle of the thermal valve described above with reference to FIG. 12. As illustrated, the valve part may basically include a guide pin 171, a valve cap 172, a casing 173, a cover part 175, an elastic portion 174, a wax portion 176, and a valve plate 177 and further include a main spring 178 and a sub-spring 179 to implement a smoother operation.

The guide pin 171 extends in an extension direction of the main space portion 163 and is provided in the main space portion 163. The guide pin 171 corresponds to a “piston” in FIG. 12. However, in the bypass valve 160 of the present invention, the guide pin 171 is fixed without moving and thus designated to another name.

The valve cap 172 fixes one side of the guide pin 171 to one side of the main space portion 163. A seal ring 172a having an O-ring shape may be provided between the valve cap 172 and an inner wall of the main space portion 163 to prevent a leak. In addition, a snap ring 172b may be provided at an upper end of the valve cap 172 to prevent withdrawal of the valve cap 172.

The casing 173 is formed in a container shape opened at one end thereof and accommodates the guide pin 171. An inner wall of the casing 173 is spaced apart from an outer surface of the guide pin 171. That is, the casing 173 corresponds to the “housing” in FIG. 12. Meanwhile, as described above, the guide pin 171, which corresponds to the “piston” in FIG. 12, is fixed to one side of the main space portion 163 by the valve cap 172. In the thermal valve in FIG. 12, the “housing” is fixed, such that the “piston” is configured to move relative to the “housing” in accordance with the change in temperature. However, in the bypass valve 160 of the present invention in FIG. 13, the guide pin 171 is fixed, and the casing 173 moves relative to the guide pin 171 in accordance with the change in temperature. Meanwhile, as can be seen from the operational principle of the thermal valve in FIG. 12, the operation of the valve is implemented as the wax changes in phase in accordance with the ambient temperature environment. Therefore, the heat transfer between the ambient temperature environment and the wax needs to be actively and appropriately performed. Therefore, the casing 173 may be made of a metallic material that facilitates the heat transfer. For example, the casing 173 may be made of brass or the like.

The elastic portion 174 is provided to surround the guide pin 171 and corresponds to the “elastomer” in FIG. 12. The elastic portion 174 may be made of a material, which is elastically deformed well, to effectively press the guide pin 171. For example, the elastic portion 174 may be made of rubber or the like.

The cover part 175 is movable along the guide pin 171 and serves to seal an open end of the casing 173. In this case, as illustrated in FIG. 13, a structure is formed in which a part of the upper end of the elastic portion 174 is fitted with a lower inner side of the cover part 175. As illustrated, a sealing plate 175a may be provided between the cover part 175 and the elastic portion 174 to prevent foreign substances from being introduced between the elastic portion 174 and the guide pin 171.

The wax portion 176 fills the space between the elastic portion 174 and the casing 173 and changes in phase to a liquid or solid phase in accordance with a temperature. The wax portion 176 corresponds to the “expansion wax” in FIG. 12. In general, it is known that the refrigerant introduced into the condenser in the cooling mode has about 81 degrees or higher, and the refrigerant introduced into the evaporator in the heating mode has about 64 degrees or lower. In view of this, it is preferred that the wax portion 176 is a material that becomes liquid at about 81 degrees or higher and solid at about 64 degrees or lower. As a specific example, the wax portion 176 may be a paraffin-based wax having a characteristic temperature changeable range of 45 degrees to 120 degrees.

The valve plate 177 is provided at the other side of the casing 173 and serves to open or close the communication between the main space portion 163 and the sub-space portion 164. In this case, a fixing ring 177a may be assembled by being press-fitted with a lower side of the valve plate 177 so that the valve plate 177 may be securely fixed to the casing 173.

Two opposite ends of the main spring 177 are respectively supported by the valve plate 177 and one end of the casing 173, and the main spring 177 serves to absorb excessive expansion of the wax portion 176. The components including the guide pin 171 and the valve plate 177 may operate as the thermal valve. However, as the main spring 177 is provided, the operation of the valve may be more stably performed.

Two opposite ends of the restoring spring 179 are respectively supported by the valve plate 177 and the other side of the sub-space portion 164, and the restoring spring 179 serves to assist in restoring the casing 173 to an original position. Even though the restoring spring 179 is not provided, the position of the casing 173 is restored as the wax portion 176 changes to a solid phase. However, the operation of the valve may be more smoothly performed by the restoring force of the restoring spring 179.

Hereinafter, an operation of the bypass valve 160 will be described in more detail with reference to FIGS. 14 and 15.

FIG. 14 is a perspective view illustrating the operation of the bypass valve in the cooling mode. As described above, in the cooling mode, the heat exchanger 100 operates as the condenser, and the high-temperature refrigerant is introduced into the inlet port 130. As described above, FIG. 14 illustrates the first embodiment. In this case, the introduced refrigerant needs to be supplied only to the first path \textcircled{1}, and the bypass valve 160 needs to be closed. As described above, because the refrigerant has a relatively high temperature, the wax portion 176 changes in phase to a liquid phase, and the volume is increased, such that the wax portion 176 presses the elastic portion 174. Then, (as described with reference to the operational principle of the thermal valve in FIG. 12), the guide pin 171 receives a squeezing force by being pressed by the elastic portion 174. However, in the case of the thermal valve in FIG. 12, the “housing” is fixed, and the “piston” is moved. In contrast, in the case of the bypass valve 160 of the present invention, the guide pin 171 corresponding to the “piston” is fixed, such that the casing 173 corresponding to the “housing” is moved. In this case, because the valve plate 177 is provided at the other side of the casing 173, the valve plate 177 closes the communication between the main space portion 163 and the sub-space portion 164 when the casing 173 moves. As described above, the first communication path 161 is always opened, whereas the second communication path 162, which communicates with the sub-space portion 164, is closed by the above-mentioned operation of the valve plate 177. As a result, the refrigerant is supplied only to the first path \textcircled{1}.

FIG. 15 is a perspective view illustrating the operation of the bypass valve in the heating mode. As described above, in the heating mode, the heat exchanger 100 operates as the evaporator, and the low-temperature refrigerant is introduced into the inlet port 130. As described above, FIG. 15 illustrates the first embodiment. In this case, the introduced refrigerant needs to be supplied to the first path \textcircled{1} and the third path \textcircled{3}, and the bypass valve 160 needs to be opened. As described above, because the refrigerant has a relatively low temperature, the wax portion 176 changes in phase to a solid phase, and the volume is decreased, such that the wax portion 176 does not press the elastic portion 174. Therefore, the casing 173 is restored to the original position, and the valve plate 177 opens the communication between the main space portion 163 and the sub-space portion 164. As described above, the first communication path 161 is always opened, whereas the second communication path 162, which communicates with the sub-space portion 164, is opened by the above-mentioned operation of the valve plate 177. As a result, the refrigerant is supplied to the first path \textcircled{1} and the third path \textcircled{3}.

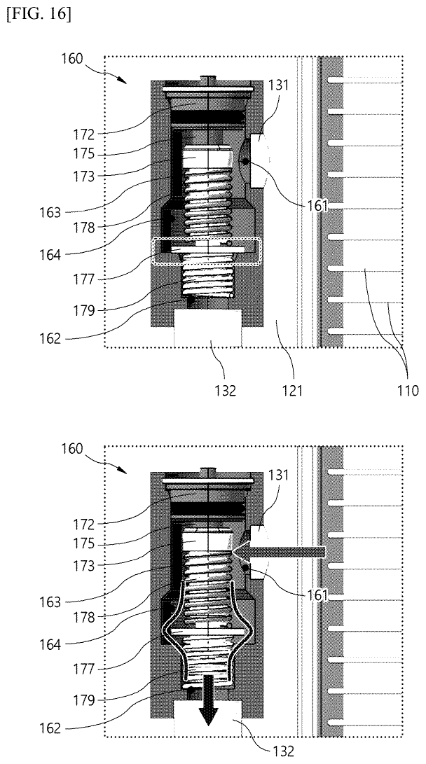

FIG. 16 is a cross-sectional view illustrating the operation of the second embodiment of the bypass valve in the cooling/heating mode. The top view in FIG. 16 illustrates the cooling mode, and the bottom view in FIG. 16 illustrates the heating mode. FIGS. 13 to 15 illustrate the first embodiment of the bypass valve and illustrates the structure in which the inlet port 130 is formed on the bypass valve 160. However, FIG. 16 illustrates the second embodiment of the bypass valve. As illustrated, the inlet port 130 is not formed on the bypass valve 160, and only the first communication path 161 and the second communication path 162 are formed.

In the first embodiment, because the inlet port 130 is formed in the bypass valve 160, the first communication path 161 is naturally formed at the position that communicates with the first path \textcircled{1}. In contrast, in the second and third embodiments, the inlet port 130 is not formed in the bypass valve 160, and the first communication path 161 is connected to the bypass port 131 that communicates with the second path \textcircled{2}. In addition, as in the first embodiment, the second communication path 162 is connected to the bypass path 132. In the first embodiment, the bypass path 132 is connected to the bypass port 131 (that communicates with the third path \textcircled{3} in the first embodiment. In the second embodiment, the bypass path 132 is connected to the outlet port 140.

Even in second embodiment, in case that the refrigerant has a high temperature in the cooling mode, the bypass valve 160 operates to be closed, as illustrated in FIG. 14, such that the valve plate 177 closes the second communication path 162. Therefore, the route along which the refrigerant flows directly to the outlet port 140 is blocked, such that the refrigerant having passed through the first and second paths \textcircled{1} and \textcircled{2} flows to the third and fourth paths \textcircled{3} and \textcircled{4} in an original manner. In case that the refrigerant has a low temperature in the heating mode, the bypass valve 160 operates to be opened, as illustrated in FIG. 15, such that the valve plate 177 opens the second communication path 162. Therefore, the refrigerant having passed through the first and second paths \textcircled{1} and \textcircled{2} may flow directly to the outlet port 140 along the opened second communication path 162 through the bypass path 132 and be discharged. Therefore, the refrigerant does not flow to the third and fourth paths \textcircled{3} and \textcircled{4}, such that the flow path is further simplified.

The third embodiment operates in the same way as the second embodiment illustrated in FIG. 16, but only the arrangement direction may be changed to the horizontal arrangement. Therefore, the separate drawings and description related to the bypass valve in the third embodiment will be omitted.

The present invention is not limited to the above embodiments, and the scope of application is diverse. Of course, various modifications and implementations made by any person skilled in the art to which the present invention pertains without departing from the subject matter of the present invention claimed in the claims.

### INDUSTRIAL APPLICABILITY

According to the present invention, the heat exchanger is designed such that the number of paths is changed, as necessary, which may basically solve the problem in which the cooling performance and the heating performance vary depending on the number of paths.

In addition, in the present invention, the thermal bypass valve is used to change the refrigerant path by sensing the refrigerant temperature, such that the paths optimized for the cooling and heating modes may be formed. Therefore, it is possible to simply change the heat exchanger path without using a separate electrical signal and electric power and implement the excellent performance in both the cooling and heating modes.

1. A heat exchanger comprising:
a plurality of tubes disposed in parallel with one another and configured to define a core region in which a refrigerant flows;
a pair of header tanks provided at two opposite ends of the tubes; and
a plurality of baffles provided in the header tanks,
wherein a plurality of paths is formed in the core region by the plurality of baffles, and a bypass valve, which selectively bypasses at least some of the plurality of paths, communicates with at least any one side of the pair of header tanks.

2. The heat exchanger of claim 1, further comprising:
a receiver dryer configured to separate the refrigerant into a gaseous refrigerant and a liquid refrigerant,
wherein at least a part of the refrigerant, which is introduced the heat exchanger when the bypass valve is opened, flows through some of the plurality of paths, passes through the receiver dryer, and then is discharged.

3. The heat exchanger of claim 2,
wherein the bypass valve is disposed at an upstream side of the receiver dryer based on a flow of the refrigerant.

4. The heat exchanger of claim 3, comprising:
a bypass port provided in the header tank; and
a bypass path connected to the bypass valve and configured to allow the refrigerant to bypass the path when the bypass path is opened.

5. The heat exchanger of claim 1,
wherein the number of paths in the core region is four.

6. The heat exchanger of claim 1,
wherein the bypass valve is opened or closed in accordance with a temperature.

7. The heat exchanger of claim 6,
wherein the heat exchanger serves as a condenser and closes the bypass valve in a cooling mode, and the heat exchanger serves as an evaporator and opens the bypass valve in a heating mode.

8. The heat exchanger of claim 1,
wherein the entire refrigerant introduced into the heat exchanger passes through all the paths in the core region and then is discharged to the outside of the heat exchanger when the bypass valve is closed, and at least a part of the refrigerant introduced into the heat exchanger is discharged to the outside of the heat exchanger without passing through at least one path in the core region when the bypass valve is opened.

9. The heat exchanger of claim 8,
wherein the bypass valve is provided in a flange block having an inlet port that communicates with the header tank.

10. The heat exchanger of claim 9, further comprising:
a receiver dryer configured to separate the refrigerant into a gaseous refrigerant and a liquid refrigerant,
wherein the refrigerant, which flows through all the paths positioned at an upstream side of the receiver dryer, and the refrigerant, which is introduced through the opened bypass valve and flows through the bypass path, merge with each other and pass through the receiver dryer when the bypass valve is opened.

11. The heat exchanger of claim 1, further comprising:
a receiver dryer configured to separate the refrigerant into a gaseous refrigerant and a liquid refrigerant,
wherein the refrigerant passes through the receiver dryer when the bypass valve is closed, and the refrigerant does not pass through the receiver dryer when the bypass valve is opened.

12. The heat exchanger of claim 11,
wherein the bypass valve is provided between inlet and outlet ports formed in the header tank.

13. The heat exchanger of claim 12,
wherein the bypass valve is connected to the outlet port, and the refrigerant passes only through the path, which is positioned at an upstream side of the bypass valve in the core region, and is discharged through the outlet port when the bypass valve is opened.

14. The heat exchanger of claim 11,
wherein the pair of header tanks is spaced apart from each other leftward and rightward such that the tubes are disposed horizontally, or the pair of header tanks is spaced apart from each other in an upward/downward direction such that the tubes are disposed vertically.

15. A bypass valve, which is provided in the heat exchanger of claim 1 and configured to be opened and closed in accordance with a temperature of a refrigerant to allow the refrigerant to bypass when the bypass valve is opened, the bypass valve comprising:
a first communication path connected to the heat exchanger and configured to allow the refrigerant to flow therethrough;
a second communication path connected to a bypass route of the heat exchanger and configured to allow the refrigerant to flow therethrough;
a main space portion configured to communicate with the inlet port and the first communication path and configured to accommodate a valve part configured to perform opening and closing operations; and
a sub-space portion configured to communicate with the main space portion and having a smaller cross-sectional area than the main space portion, in which the communication between the sub-space portion and the main space portion is opened or closed by an operation of the valve part, and the sub-space portion communicates with the second communication path.

16. The bypass valve of claim 15, wherein the valve part comprises:
a guide pin extending in an extension direction of the main space portion and provided in the main space portion;
a valve cap configured to fix one side of the guide pin to one side of the main space portion;
a casing formed in a container shape opened at one end thereof and configured to accommodate the guide pin, the casing having an inner wall spaced apart from an outer surface of the guide pin;
an elastic portion provided to surround the guide pin;
a cover part configured to be movable along the guide pin and configured to seal an open end of the casing;
a wax portion configured to fill a space between the elastic portion and the casing and configured to be changed in phase to a liquid or solid phase in accordance with a temperature; and
a valve plate provided at the other side of the casing and configured to open or close communication between the main space portion and the sub-space portion.

17. The bypass valve of claim 16, wherein in the valve part,
in a cooling mode, the refrigerant has a relatively high temperature, the wax portion changes in phase to a liquid phase, and a volume is increased, such that the wax portion presses the elastic portion, the guide pin receives a squeezing force by being pressed by the elastic portion, such that the casing moves, and the valve plate closes the communication between the main space portion and the sub-space portion, and
wherein in a heating mode, the refrigerant has a relatively low temperature, the wax portion changes in phase to a solid phase, and a volume is decreased, such that the casing is restored to an original position, and the valve plate opens the communication between the main space portion and the sub-space portion.

18. The bypass valve of claim 16, wherein the valve part comprises:
a main spring having two opposite ends respectively supported by the valve plate and one side of the casing and configured to absorb excessive expansion of the wax portion; and
a restoring spring having two opposite ends respectively supported by the valve plate and the other side of the sub-space portion and configured to assist in restoring the casing to the original position.
